(19) United States
(12) Patent Application Publication
(10) Pub. No.: US 2013/0323456 A1
(43) Pub. Date: Dec. 5, 2013

(54) ECO-FRIENDLY TUFTED CARPET FOR VEHICLE HAVING IMPROVED ABRASION RESISTANCE

(71) Applicants: HYUNDAI MOTOR COMPANY, Seoul (KR); KIA MOTORS CORPORATION, Seoul (KR)

(72) Inventors: Won Jin Seo, Suwon (KR); Jung Wook Lee, Seoul (KR); Dong Uk Lee, Hwaseong (KR); Bong Hyun Park, Gunpo (KR); Kie Youn Jeong, Suwon (KR)

(73) Assignees: KIA MOTORS CORPORATION, Seoul (KR); HYUNDAI MOTOR COMPANY, Seoul (KR)

(21) Appl. No.: 13/623,364

(22) Filed: Sep. 20, 2012

(30) Foreign Application Priority Data
Jun. 4, 2012 (KR) 10-2012-0059623

(51) Int. Cl. D02G 3/04; D05C 15/04; B32B 38/00; D05C 17/02

(52) U.S. Cl. 428/97; 156/72

(57) ABSTRACT

Disclosed is a tufted carpet for a vehicle. The tufted carpet for the vehicle is manufactured by implanting a spun yarn into a base fabric, wherein the spun yarn is formed from a material mixture of about 85 wt % to about 95 wt % polyethylene terephthalate (PET) and about 5 to about 15 wt % polytrimethylene terephthalate (PTT).

### CROSS-REFERENCE TO RELATED APPLICATION

This application claims under 35 U.S.C. §119(a) the benefit of Korean Patent Application No. 10-2012-0059623 filed Jun. 4, 2012, the entire contents of which are incorporated herein by reference.

### BACKGROUND

(a) Technical Field

The present invention relates to an eco-friendly tufted carpet for a vehicle. More particularly, the present invention relates to an eco-friendly tufted carpet for a vehicle with improved abrasion resistance, which incorporates into a base fabric a yarn having a mixture of a certain content ratio of polyethylene terephthalate (PET) and polytrimethylene terephthalate (PTT).

(b) Background Art

Generally, tufted carpets made of nylon and PET have been widely used for vehicles. Recently, a process of manufacturing a carpet using PTT having the advantages of both nylon and polyester has been proposed. For example, Korean Patent No. 415731 describes a method for manufacturing a carpet by implanting a yarn in which PTT is spun into a base fabric.

A PTT resin is manufactured by polymerizing ethylene glycol (EG) and 1, 3-propanediol (PDO). Since Dupont Inc. developed a method of extracting 1, 3-propanediol (PDO) from corn instead of using a petrochemical manufacturing method, 1, 3-propanediol (PDO) has been highlighted as an eco-friendly material.

To date, raw materials for commercialized vehicle carpet yarns are mostly petroleum-originated polymer resins. Because petroleum-originated polymer resins require a high processing heat during the resin synthesis, a large amount of CO₂ is released therefrom. CO₂ released to the atmosphere leads to environmental contamination and global warming. Due to rising social recognition about environment changes and the need to comply with increasingly strict environmental regulations, the development and use of eco-friendly materials has become a top priority. Under these demands, attempts to replace conventional vehicle carpet materials with eco-friendly materials have been made. However, the success in such attempts has been limited due to the general lack of durability of eco-friendly materials. Particularly, in the case of carpets for vehicles, fiber on the surface of carpets can be easily abraded due to continuous friction with passenger's boots, which shortens the length of the fiber, and more seriously, exposes the base fabric due to complete abrasion of the surface fiber. Thus, there are many difficulties in replacing the carpet yarn for vehicles with eco-friendly materials.

As a raw material for a yarn containing bio-components, a synthetic yarn in which a mixture of a polytrimethylene terephthalate (PTT) and polylactic acid (PLA) is spun is known. Since both PTT and PLA resins can be spun in a form of a Bulked Continuous Filament (BCF) and include eco-friendly components, they are being used as raw materials in yarn for clothing and family use. However, both PTT and

PLA resins have low abrasion resistance and, thus, their use in a carpet for a vehicle is limited. In order for PTT and PLA resins to be suitably applied in carpet for a vehicle, they need to have an abrasion endurance of at least 1,000 times. However, since PTT and PLA resins show an abrasion endurance below 300 times, due to low durability which is a characteristic and limitation of bio-resins, they cannot be successfully applied to carpets for vehicles.

Korean Patent No. 587121 describes a method of manufacturing a polyester fiber with dyeability, excellent softness, and excellent dyeing uniformity by spinning a material mixture containing 70 wt % to 95 wt % PET, having an intrinsic viscosity of 0.50 to 0.65, and 5 wt % to 30 wt % PTT, having an intrinsic viscosity of 0.80 to 1.0. However, while the polyester fiber is suitable for piece-dyed innerwear products and clothing having excellent softness at a low dyeing temperature condition, it is not suitable as materials for carpets in vehicles where continuous friction with the rough surfaces (e.g., shoes) occurs. For example, using an abrasion wheel of a Taber abrasion tester which is widely used for the abrasion test of fiber, the polyester fiber is tested for use as a clothing material by rotating a soft surfaced CS-10 abrasion wheel 300 times to examine the abrasion degree. On the other hand, the abrasion degree of carpets for vehicles is tested by rotating a very rough surfaced H-18 abrasion wheel over 1000 times. Accordingly, the polyester fiber is limited in its ability to endure a severe frictional environment of a vehicle. Unlike a fiber for clothing, carpets for vehicles are formed of a Bulked Continuous Filament (BCF) type of yarn, and a massive feeling needs to be increased by performing crimping. Also, there is a clear difference from clothing fiber in that the colors are realized through a spinning process by adding a color master batch in order to supplement the weakness of abrasion resistance due to lying of piles after dyeing.

Thus, there is a need for a material for a carpet yarn that uses an eco-friendly material with a sufficient abrasion resistance, and which is suitable for production of carpets for vehicles used under severe environmental conditions.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an eco-friendly tufted carpet for a vehicle, having improved abrasion resistance.

In one aspect, the present invention provides a method for manufacturing a tufted carpet for a vehicle, including: forming a material mixture by mixing about 85 wt % to about 95 wt % PET and about 5 wt % to about 15 wt % PTT; forming a yarn by melting and spinning the material mixture at a temperature of about 270° C. to about 300° C.; forming a twisted yarn by twisting the yarn into 2- or 3-ply yarn in a cable twister; implanting the twisted yarn into a primary base fabric, wherein the primary base fabric may be selected from PET and PP films, and performing tufting such that the weight of the yarn ranges from about 10 oz/yd² to about 90 oz/yd² to thereby form a tufted carpet; and attaching and backing the tufted carpet to a secondary base fabric, wherein the secondary base fabric may be selected from the PET and PP films.

In another aspect, the present invention provides a tufted carpet for a vehicle comprising a spun yarn implanted in a base fabric, wherein the spun yarn is formed from a material mixture of PET and PTT, particularly a mixture of about 85 wt % to about 95 wt % PET and about 5 to about 15 wt % PTT. According to various embodiments, the base fabric is selected from PET and PP films

Other aspects and exemplary embodiments of the invention are discussed infra.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The above and other features of the invention are discussed infra.

Hereinafter, exemplary embodiments of the present invention will be described in detail with reference to the accompanying drawings.

The present invention provides an eco-friendly tufted carpet for a vehicle, having improved abrasion resistance.

In an embodiment of the present invention, a combination of PTT, which is an eco-friendly material, and PET is used to form a carpet yarn. In particular, PTT is used as a raw material of a carpet yarn, and PET is used together with the PTT to overcome the low abrasion resistance and low durability of PTT that are inherent limitations of PTT. According to an exemplary embodiment, a carpet yarn is provided which uses a mixture of about 85 to about 95 wt % PET and about 5 to about 15 wt % PTT as a raw material. The quality of the durability of a carpet may be dependent on the mixture ratio of PTT and PET and, thus, the mixture ration can be varied so as to achieve desired properties. As the content of PTT in the yarn increases, the abrasion resistance becomes weaker. As such, according to preferred embodiments so as to provide a carpet having a suitable durability for use in a vehicle, the content of PTT is limited to no greater than about 15 wt %. When the content of PTT exceeds about 15 wt %, the durability may not reach the durability requirements of a carpet for a vehicle. More preferably, the content of PET may be maintained within a range from about 90 to about 95 wt %, with the balance being PTT.

In an embodiment of the present invention, the PET has a specific gravity of about 1.3 to about 1.5, a melting point of about 225° C. to about 233° C., a glass transition temperature of about 45° C. to about 55° C., a crystallization temperature of about 163° C. to about 180° C., and an intrinsic viscosity of about 0.9 to about 1.0.

According to preferred embodiments, the PET has a high viscosity. In particular, the strength and the abrasion resistance of a yarn increases due to a high viscosity, and thus, providing a yarn with a suitably high viscosity may provide the yarn with durability to meet the severe abrasion requirements of a vehicle.

In an embodiment of the present invention, the PTT used as a material of the carpet yarn has an intrinsic viscosity that is similar to that of the PET. In particular, according to an exemplary embodiment, the PTT has an intrinsic viscosity of about 0.9 to about 1.0. When a viscosity difference between PET and PTT increases, the spinning characteristics may be negatively impacted and to a greater extent. Accordingly, the viscosity difference between PET and PTT is preferably minimized.

According to embodiments of the present invention, the yarn obtained by spinning the material mixture having the above conditions has a strength of about 3.3 gf/d to about 4.3 gf/d.

According to another embodiment of the present invention, a method for manufacturing an eco-friendly tufted carpet for a vehicle, having improved abrasion resistance is provided. Hereinafter, the method for manufacturing the tufted carpet according to an embodiment of the invention will be described in detail by stages.

i) A material mixture is manufactured by mixing a suitable amount of PET and PTT, particularly about 85 wt % to about 95 wt % PET and about 5 wt % to about 15 wt % PTT. A color master batch may be further included in the material mixture to provide a desired color of a carpet. According to various embodiments, the color master batch may be added in range from about 0.01 weight part to about 5 weight parts with respect to 100 weight part of the material mixture (PET and PTT).

ii) The material mixture, which may or may not include the color master batch, is melted at a suitable temperature, particularly about 270° C. to about 300° C. The melted material mixture is then spun to manufacture a yarn. The melted material mixture may be spun by any conventional method, such as with a spinning nozzle, and resin solidification may be performed at a room temperature by a dry method or under any other suitable conditions known in the art. According to an exemplary embodiment, the winding speed of the yarn ranges from about 1,500 m/min to about 2,000 m/min. In order to provide a crimp that has the characteristics of a Bulked Continuous Filament (BCF) yarn, hot air of about 200° C. to about 250° C. may be used to crimp a filament in an irregular three-dimensional pattern. The crimp rate may vary and, for example, may range from about 10% to about 50% (wherein crimp rate is the difference between the distance between two points on the filament when it is relaxed and when it is straightened under suitable tension, expressed as a percentage of the relaxed distance). The strength of the yarn manufactured may be maintained within a range from about 3.3 gf/d to about 4.3 gf/d.

iii) A twisted yarn may then be manufactured by twisting the yarn formed in ii) into 2ply yarn or 3ply yarn in a cable twister or other suitable means. In this embodiment, some twisting and tying may be performed at the cable twister in order to improve the bundling strength of the yarn. According to an exemplary embodiment, twisting and tying is performed about 10 times to about 40 times per meter.

According to embodiments of the present invention, when interlocking is provided below 10 times in an interlocking machine, the bundling strength may be reduced resulting in the generation of large quantities of lint. As understood in the art, “interlocking” is generally a method to plait yarns by injecting air between yarns thereby producing an artificial tangle while twisting.

Accordingly, a large amount of napped fiber may occur in the cable twister during the cabling. Further, in a subsequent tufting step carried out on the twisted yarn, the characteristics of the yarn may be deteriorated during cutting. Thus, for example, the exterior of the yarn may be deteriorated due to pile untying of a carpet that is finally treated by a shearing process, and the durability may be reduced. On the other hand, when interlocking is above 40 times, the interlocking may be maintained at untied portions even when treated by dying and post-processing, thus causing a damage to the exterior of the carpet.

iv) The twisted yarn may then be implanted into a primary base fabric for tufting. According to various embodiments, the twisted yarn may be implanted into the base fabric at a certain gauge and stitch using a typical carpet yarn weaving machine to provide desired properties. If desired, an implanted fiber having a loop shape may be cut at the end thereof by a cutter by a certain length. The surface after cutting may subsequently be finally trimmed at the end thereof through shearing, which can provide a uniform length of cut fibers. According to embodiments of the invention, the primary base fabric may include conventional base fabrics, and in particular, a PET or PP film.

v) The tufted carpet formed by iv) may then be adhered and backed to a secondary base fabric to manufacture a carpet for a vehicle. According to an exemplary embodiment, the tufted carpet may be treated by a latex coating, and then may be attached and backed to the secondary base fabric. The secondary base fabric may be any conventional base fabrics such as, for example, PET or PP film. According to various embodiments, as an auxiliary mat, polyvinyl carbonate (PVC) or stylene-butadiene-stylene (SBS) resin may also be used as a backing reinforcing material.

As described above, the present invention provides a tufted carpet which is a bio-mat that uses an eco-friendly material, and which has excellent abrasion resistance.

### EXAMPLES

The following examples illustrate the invention and are not intended to limit the same.

### Examples 1 to 3 and Comparative Example 1

In a spindraw spinner, a PET chip, a PTT chip, and a color master batch were put into a vacuum rotation-type drier, and were mixed at a temperature of about 150° C. for about 10 hours. The properties of the PET chip and the PTT chip and the mixture ratio thereof are shown in Table 1 below.

A material mixture was melted at a temperature of about 290° C., and then spun through a spinning nozzle and cooled to a temperature of about 17° C. at a speed of about 0.4 m/min. The internal temperature of a texturing unit was adjusted to a temperature of about 200° C., and crimp was performed at a pressure of about 100 psi. Thereafter, cooling was performed at a temperate of about 15° C. in a cooling drum, and bundling was performed 20 times per minute at a pressure of about 4.0 kg/m² by a bundling machine. The yarn was relaxed by passing through two godet rollers, while operating at a speed of about 2,543 m/min in the second godet roller whose speed was about 20% less than that of the first godet roller, and the speed of the winding machine was about 2,600 m/min, thus manufacturing a complex BCF.

The complex BCF was 2ply-twisted through Z-twisting in a cable twister, and then heat-fixed by a super bar. The heat-fixed twisted yarn was implanted into a PP base fabric in a tufting machine of 1/10 gauge for tufting. In this case, the pile was cut, and the height was about 12 mm and the stitch was about 13/inch. The weight of the yarn was about 32 oz/yd².

After latex coating, the tufted carpet was adhered and backed to PET which was used a secondary base fabric. Thereafter, shearing was performed with a spiral knife to manufacture the final tufted carpet.

The abrasion resistance of the tufted carpet manufactured through the above manufacturing method was evaluated using an ISO 5470-1 testing machine and an abrasion wheel H-18 of 1 kg weight. The test results are shown in Table 1 below.

TABLE 1

| | Material Mixture (g) | | | Abrasion |
|---|---|---|---|---|
| | | | Color Master | Resistance |
| Division | PET¹⁾ | PTT²⁾ | Batch³⁾ | (times) |
| Example 1 | 90 | 10 | 2 | 1200 |
| Example 2 | 95 | 5 | 2 | 1500 |
| Example 3 | 85 | 15 | 2 | 700 |
| Comparative | 0 | 100 | 2 | 300 |
| Example 1 | | | | |

¹⁾PET: Product from Hyosung Inc., specific gravity of 1.3 to 1.5, melting point of 225° C. to 233° C., glass transition temp of 45° C. to 55° C., crystallization temp of 163° C. to 180° C., intrinsic viscosity of 0.91.
²⁾PTT: Product from Dupont Inc., named SORONA, intrinsic viscosity of 0.92.
³⁾Color master batch: Product from Haniltoyo Inc., named VK-14.

As demonstrated in the Examples, since PTT is used together with PET in the present invention, low abrasion resistance and low durability of PTT, which are inherent limitations of PTT, were improved compared to a conventional tufted carpet containing only PTT. In particular, as demonstrated in Examples 1 and 2, tufted carpets prepared in accordance with the present invention were capable of enduring friction in excess of 1,000 times.

According to embodiments of the present invention (Examples 1-3), since an eco-friendly material including PTT is used, about 30% energy reduction and about 63% greenhouse gas reduction effects can be achieved compared to conventional use of nylon.

Further, by spinning a material mixture using a solution dyeing process according to the present invention, rather than a typical 100% PTT carpet or nylon manufactured by a piece dyeing process, uniform dyeing characteristics can be ensured.

Accordingly, a carpet according to the present invention is useful as a carpet for a vehicle even when used in severe environments.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A tufted carpet for a vehicle, comprising:
a spun yarn implanted in a base fabric, the spun yarn formed from a material mixture comprising about 85 wt % to about 95 wt % polyethylene terephthalate (PET) and about 5 to about 15 wt % polytrimethylene terephthalate (PTT).

2. The tufted carpet of claim 1, wherein the spun yarn further comprises about 0.01 to about 5 weight part of a color master batch, based on 100 weight part of the material mixture.

3. The tufted carpet of claim 1, wherein the polyethylene terephthalate has an intrinsic viscosity of about 0.9 to about 1.0 and the polytrimethylene terephthalate has an intrinsic viscosity of about 0.9 to about 1.0.

4. The tufted carpet of claim 1, wherein the polyethylene terephthalate has a specific gravity of about 1.3 to about 1.5, a melting point of about 225° C. to about 233° C., a glass transition temperature of about 45° C. to about 55° C., and a crystallization temperature of about 163° C. to about 180° C.

5. The tufted carpet of claim 3, wherein the polyethylene terephthalate has a specific gravity of about 1.3 to about 1.5, a melting point of about 225° C. to about 233° C., a glass transition temperature of about 45° C. to about 55° C., and a crystallization temperature of about 163° C. to about 180° C.

6. The tufted carpet of claim 1, wherein the strength of the spun yarn ranges from about 3.3 gf/d to about 4.3 gf/d.

7. A method for manufacturing a tufted carpet for a vehicle, comprising:
forming a material mixture by mixing about 85 wt % to about 95 wt % polyethylene terephthalate and about 5 wt % to about 15 wt % polytrimethylene terephthalate;
forming a yarn by melting and spinning the material mixture at a temperature of about 270° C. to about 300° C.;
forming a twisted yarn by twisting the yarn into 2- or 3- ply yarn in a cable twister;
implanting the twisted yarn into a primary base fabric selected from PET and PP films; and
performing tufting such that the weight of the yarn ranges from about 10 oz/yd² to about 90 oz/yd².

8. The method of claim 7, further comprising, after tufting, attaching and backing the tufted implanted yarn to a secondary base fabric selected from PET and PP films.

9. The method of claim 7, wherein the polyethylene terephthalate has an intrinsic viscosity of about 0.9 to about 1.0 and the polytrimethylene terephthalate has an intrinsic viscosity of about 0.9 to about 1.0.

10. The method of claim 7, wherein the polyethylene terephthalate has a specific gravity of about 1.3 to about 1.5, a melting point of about 225° C. to about 233° C., a glass transition temperature of about 45° C. to about 55° C., and a crystallization temperature of about 163° C. to about 180° C.

11. The method of claim 9, wherein the polyethylene terephthalate has a specific gravity of about 1.3 to about 1.5, a melting point of about 225° C. to about 233° C., a glass transition temperature of about 45° C. to about 55° C., and a crystallization temperature of about 163° C. to about 180° C.

12. The method of claim 7, wherein the strength of the twisted yarn ranges from about 3.3 gf/d to about 4.3 gf/d.
